(19) United States
(12) Patent Application Publication
(10) Pub. No.: US 2020/0133271 A1
(43) Pub. Date: Apr. 30, 2020

(54) MOBILE VENDING USING AN AUTONOMOUS ALL-TERRAIN VEHICLE

(71) Applicant: Honda Motor Co., Ltd., Tokyo (JP)

(72) Inventors: Jason W. GRUNDEY, Wapakoneta, OH (US); Richard M. LOWERY, JR., London, OH (US); Naoki MURASAWA, Dublin, OH (US)

(21) Appl. No.: 16/177,009

(22) Filed: Oct. 31, 2018

(51) Int. Cl. G05D 1/00; G06Q 10/08; G05D 1/02; B64C 39/02

(52) U.S. Cl. CPC G05D 1/0088; G06Q 10/0832; B64C 2201/128; B64C 39/024; G05D 1/0248

(57) ABSTRACT

A system for providing goods to a customer includes an autonomous vehicle, the autonomous vehicle including a first controller, a camera in communication with the first controller for supplying image data to the controller, a global positioning satellite apparatus for determining a position of the autonomous vehicle in communication with the first controller, and a ranging unit for determining a distance to an object from the autonomous vehicle in communication with the first controller. The system also includes a mobile vending machine affixed to the autonomous vehicle, the mobile vending machine including a second controller, a user interface for taking an order from the customer in communication with the second controller, and a delivery apparatus in communication with the second controller for delivering the order to the customer.

### TECHNICAL FIELD

The embodiments disclosed herein are related to the field of autonomous vehicles, and more particularly when used as mobile vending machines.

### BACKGROUND

An autonomous vehicle is an unmanned vehicle that is generally capable of sensing its environment and navigating without input from a driver. An autonomous vehicle may perform autonomous driving by recognizing and determining surrounding environments through various sensors attached to the autonomous vehicle. Further, an autonomous vehicle may enable a destination to be set and move to the set destination via autonomous driving.

A vending machine is an automated machine that provides items such as snacks, beverages, or consumer products to consumers after money, a credit card, or specially designed card is inserted into the machine. Specialized vending machines that provide less common products compared to traditional vending machine items have been created and provided to consumers.

Internal communication in vending machines is typically based on the multi-drop bus (“MDB”) standard, supported by the National Automatic Merchandising Association (NAMA) and European Vending & Coffee Service Association (EVA).

After payment has been tendered, a product may become available by the machine releasing it, so that it falls in an open compartment at the bottom, or into a cup, either released first, or put in by the customer, or by unlocking of a door, drawer, or turning of a knob.

Some products need to be prepared to become available. For example, tickets are printed or magnetized on the spot, and coffee is freshly prepared. One of the most common form of vending machine, the snack machine, often uses a metal coil which when ordered rotates to release the product.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a system for providing goods to a customer includes an autonomous vehicle, the autonomous vehicle including a first controller, a camera in communication with the first controller for supplying image data to the controller, a global positioning satellite apparatus for determining a position of the autonomous vehicle in communication with the first controller, and a ranging unit for determining a distance to an object from the autonomous vehicle in communication with the first controller. The system also includes a mobile vending machine affixed to the autonomous vehicle, the mobile vending machine including a second controller, a user interface for taking an order from the customer in communication with the second controller, and a delivery apparatus in communication with the second controller for delivering the order to the customer.

According to another aspect, a method of providing goods to a consumer uses an autonomous vehicle, the autonomous vehicle comprising a controller, a camera in communication with the controller, a global positioning satellite apparatus in communication with the controller, a ranging unit in communication with the controller, and a mobile vending machine affixed to the autonomous vehicle. The method includes the steps of determining the position of the autonomous vehicle using the global positioning satellite apparatus, identifying a group of customers from image data provided by the camera to the controller, identifying a distance to the group of customers using the ranging unit, plotting a course for the autonomous vehicle to the group of customers using data from the global positioning satellite apparatus, camera, and ranging unit, directing the autonomous vehicle along the course to the group of customers, and stopping the autonomous vehicle if one of the group of customers is detected by the ranging unit within a specified distance of the autonomous vehicle.

According to yet another aspect, a method of providing goods to a consumer uses an autonomous vehicle, the autonomous vehicle comprising a controller, a camera in communication with the controller, a global positioning satellite apparatus in communication with the controller, a ranging unit in communication with the controller, an infrared sensor in communication with the first controller, and a mobile vending machine affixed to the autonomous vehicle. The method includes the steps of determining the position of the autonomous vehicle using the global positioning satellite apparatus, identifying a group of customers from data provided by the infrared sensor to the controller, identifying a distance to the group of customers using the ranging unit, plotting a course for the autonomous vehicle to the group of customers using data from the global positioning satellite apparatus, infrared sensor, and ranging unit, directing the autonomous vehicle along the course to the group of customers, and stopping the autonomous vehicle if one of the group of customers is detected by the ranging unit within a specified distance of the autonomous vehicle.

### BRIEF DESCRIPTION OF THE DRAWINGS

FIG. 1 is side view of an autonomous vehicle for use with the embodiments described herein.

FIG. 2 is a schematic view of the control system of the autonomous vehicle of FIG. 1.

FIG. 3 is a side perspective view of the autonomous vehicle equipped with a vending machine for use with the embodiments described herein.

FIG. 4 is a schematic view of an embodiment of the mobile vending machine in use with a plurality of customers.

FIG. 5 is a schematic view of an embodiment of a control system for the mobile vending machine.

FIG. 6 is a schematic view of a controller of the mobile vending machine.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

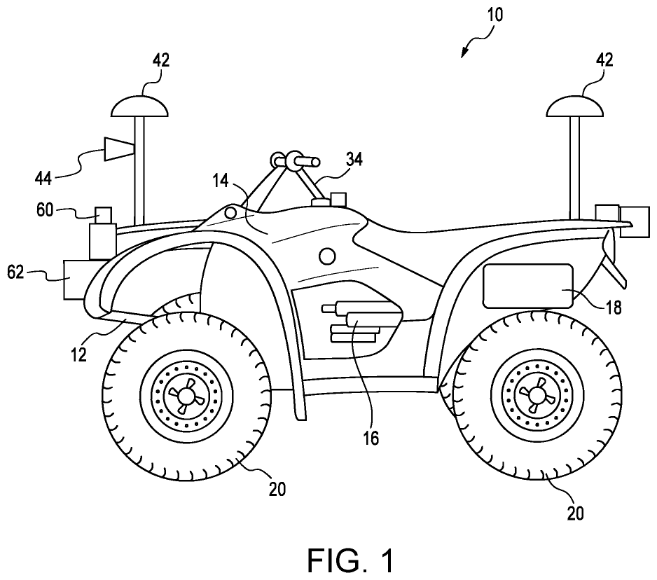

FIG. 1 is a side view of an autonomous vehicle 10 to be configured to be used as an autonomous mobile vending machine. The autonomous vehicle 10 includes a vehicle frame 12 and a body 14 attached to the vehicle frame 12. A vehicle propulsion unit 16 may also be attached to the frame 12. The vehicle propulsion unit 16 may be a four-stroke internal combustion engine, a two-stroke internal combustion engine, an electric motor, or any other appropriate motive apparatus. In the case where the vehicle propulsion unit 16 is an internal combustion engine, the autonomous vehicle may further include a fuel tank. In the case where the vehicle propulsion unit 16 is an electric motor, as illustrated in FIG. 1, the autonomous vehicle 10 may further include a battery or battery pack 18 for storing electric charge. The autonomous vehicle 10 may further include a plurality of wheels 20, four (4) in the embodiment illustrated in FIG. 1, attached to the vehicle frame 12 and driven by the vehicle propulsion unit 16. Operation of the autonomous vehicle 10 is further described in U.S. patent application Ser. No. 15/910,832 for “Control System for Autonomous All-Terrain Vehicle (ATV),” filed Mar. 2, 2018 and U.S. patent application Ser. No. 15/915,174 for “Autonomous All-Terrain Vehicle (ATV),” filed Mar. 8, 2018, both of which are hereby incorporated by reference in their entirety.

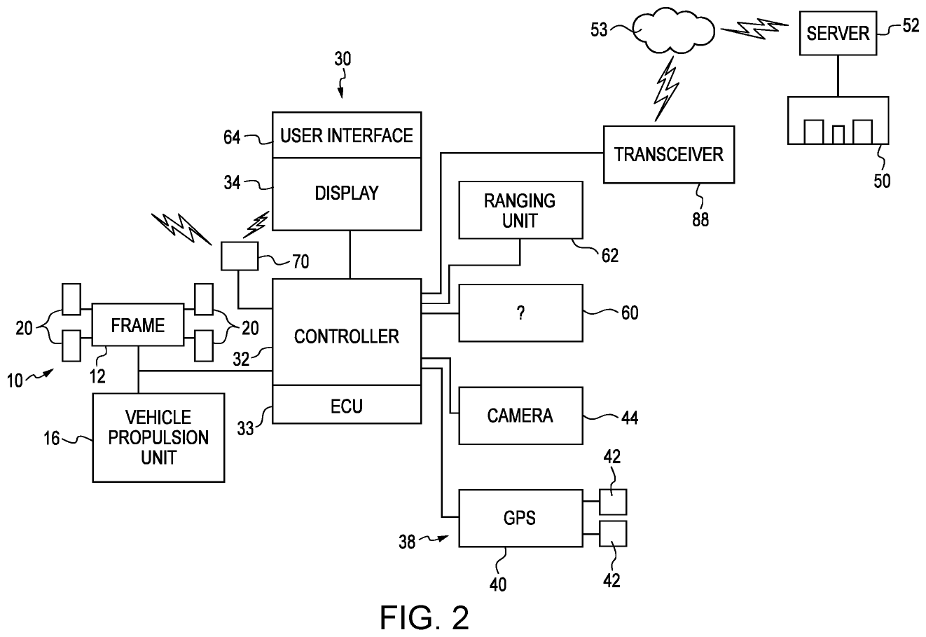

FIG. 2 is a schematic view of the control and accessory system 30 of the autonomous vehicle 10 configured to be used as an autonomous mobile vending machine. The autonomous vehicle 10 may include a controller 32, including an electronic control unit (hereinafter “ECU”) 33, for controlling operation of the autonomous vehicle 10. The controller 32 may be a dedicated controller embedded in the autonomous vehicle 10, a computer, a tablet device, or any other suitable controller for controlling the autonomous vehicle 10. The controller 32 may be in communication with the vehicle propulsion unit 16 to control the movement of the autonomous vehicle 10 by any known method to those skilled in the art. The controller 32, through a steer-by-wire system that is known to those skilled in the art, may also be in communication with the frame 12 to steer the wheels 20 in conjunction with the operative control of the vehicle propulsion unit 16.

The control and accessory system 30 may also include a number of features to support the use of the autonomous vehicle 10 as an autonomous mobile vending machine. The autonomous vehicle 10 may include a location detection system 38 to determine the location of the autonomous vehicle. In the embodiment illustrated in FIG. 2, the location detection system 38 is a global positioning system (GPS) receiver 40 in communication with the controller 32 and an associated dual GPS antennas 42 mounted on the autonomous vehicle 10, which are operable in a conventional manner known to those skilled in the art. In addition to GPS, the receiver may use other positioning standards and GNSS systems, such as GLONASS, BeiDou, Galileo, NavIC, SBAS, QZSS, and the like.

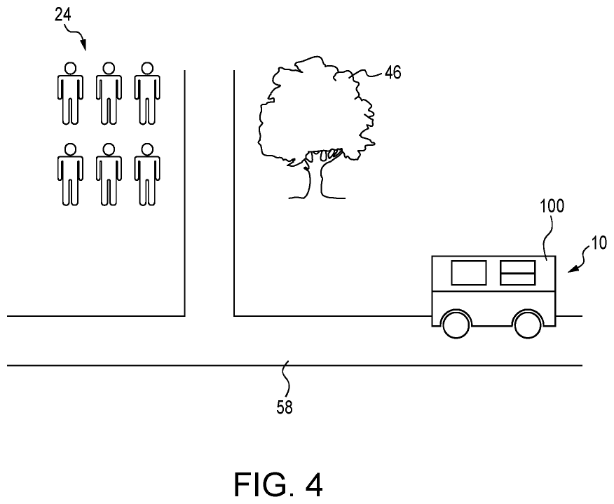

The autonomous vehicle 10 may further include a camera 44 for detecting and recording a group of customers 24 and detecting obstacles 46, as shown in FIG. 4, in front of the autonomous vehicle 10, such as trees, shrubs, buildings or structures, curbs, fences, and the like. In the embodiment illustrated, the camera 44 is an omnidirectional camera, the type of which are well known to those skilled in the art, that is in communication with the controller 32 to provide images to the controller 32 for use by the controller 32. The camera 44 provides substantially a 360° field of view, which allows the controller 32 of the autonomous vehicle 10, using images from the camera 44, to identify, using recognition techniques known to those skilled in the art, the position of the group of customers 24 relative to the location of the autonomous vehicle 10. The camera 44, along with data from the location detection system 38, may be used to identify the location of the group of customers 24, the location and size of obstacles 46, such as trees, shrubs, buildings or structures, curbs, streams or ponds, and the like.

In another embodiment, the autonomous vehicle 10 may further include an infrared sensor 60, such as a thermographic camera or a passive infrared detector, which may be used to detect the group of customers 24. The group of customers 24 emit infrared light that, when detected by the infrared sensor 60, may be used to detect their presence. This data may be communicated to the controller 32 for use along with data from the camera 44 to plot a course to the group of customers 24. The controller 32 may be configured to stop the autonomous vehicle 10 if one of the group of customers 24 comes within a specified distance of the autonomous vehicle 10, thereby permitting the one of the group of customers 24 to use the vending machine 100, described in greater detail below.

Images from the camera 44 may also be used by the controller 32 to maintain the autonomous vehicle 10 on a designated pathway 58, such as a cart path, road, sidewalk, trail, and the like. Images from the camera 44 may also be used by the controller 32 to ensure the autonomous vehicle 10 does not drive onto any other designated locations where the autonomous vehicle is prohibited, which is discussed in greater detail below.

As also schematically illustrated in FIG. 2, the autonomous vehicle may include a ranging unit 62 for use in determining a distance from the autonomous vehicle 10 to a target, such as the group of customers 24. In the embodiment, the ranging unit 62 is in communication with the controller 32, thus communicating range data from the ranging unit 62 to the controller 32, and communicating positioning and target location from the controller 32 to the ranging unit 62. In a typical mode of operation, a target object is detected by the controller 32 using an image from the camera 44, and the controller 32 directs the ranging unit 62 to determine the distance to the object. In the embodiment illustrated in FIG. 2, the ranging unit 62 is a LIDAR unit working in a conventional manner known to those skilled in the art. While a LIDAR unit is disclosed, any similar unit, such as radar, sonar, ranging sensors, or any other type of ranging unit known to those skilled in the art may be used.

The autonomous vehicle 10 also includes a user interface 64 for allowing an operator to make mode selections on the autonomous vehicle 10. The user interface 64 is in communication with the controller 32 to select a mode of operation. In the embodiment illustrated in FIG. 2, the user interface 64 is integrated within a display 34, such as a touch screen, on the autonomous vehicle 10. In alternate embodiments, the user interface 64 may include a keyboard associated with the controller 32, dedicated buttons located on the autonomous vehicle 10, or a touch screen associated with a tablet computer in communication with the controller 32 of the autonomous vehicle 10.

In yet another embodiment, the controller 32 may be in communication with a remote location 50 through a server 52 connected to the global Internet 53. The controller 32 may include a wireless communication system, such as an embedded cellular telephone 70. The autonomous vehicle 10 may alternatively or also include a wireless transceiver 88, such as a Wi-Fi transceiver, ultra wide band transceiver, a vehicle-to-vehicle (“V2V”) transceiver, or a Bluetooth module in communication with the controller 32 for communication with the remote location 50. Additionally, the controller 32 may communicate with user interface 64 on the autonomous vehicle 10 though the wireless transceiver 70, particularly if the user interface 64 is on a removable tablet computer.

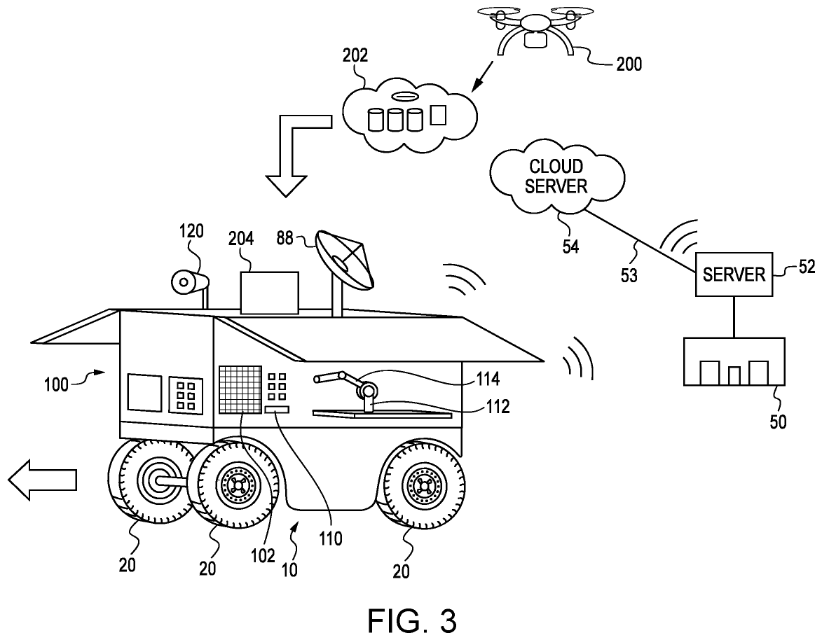

As illustrated in FIG. 3, a multi-drop bus (hereinafter “MDB”) vending machine 100 may be affixed on top of the autonomous vehicle 10. As is typical for any vending machine 100, a product may be selected using a user interface 102, such as a keypad, push buttons, or a touch monitor for better presentation. The vending machine 100 may dispense a tangible product, such as a candy bar or packaged food product, a bottle or can of water, soda pop, juices, and the like, through a door 110, or a cup 112 and dispensed beverage such as soda pop, coffee, or tea, or intangible products or services, such as cinema tickets, restaurant reservations, and the like. The vending machine 100 may be incorporated with additional features such as the purchase of a combination of products, special discounts, the redemption of coupons for the products or services, and the like. The vending machine may further be equipped with a robotic arm 114, which acts in a manner known to those skilled in the art, to deliver goods. The vending machine 100 may further include a loud speaker 120 for attracting customers.

FIG. 3 illustrates a system for remotely monitoring a vending machine 100. While the embodiment describes one vending machine 100, the system may be applied to manage a plurality of autonomous vehicles 10, each with and as associated vending machine 100. The system may include a server 52 at a remote location 50, such as a warehouse or office or, alternatively a cloud server 54, a vending machine 100, and a network 53. The server 52 may be electrically connected to vending machine 100 via the network 53. The network 53 may be a wireless connection through a mobile telephone network, or through an Internet connection through a Wi-Fi network, ultra wide band (“UWB”) network, or any other wireless network known to those skilled in the art.

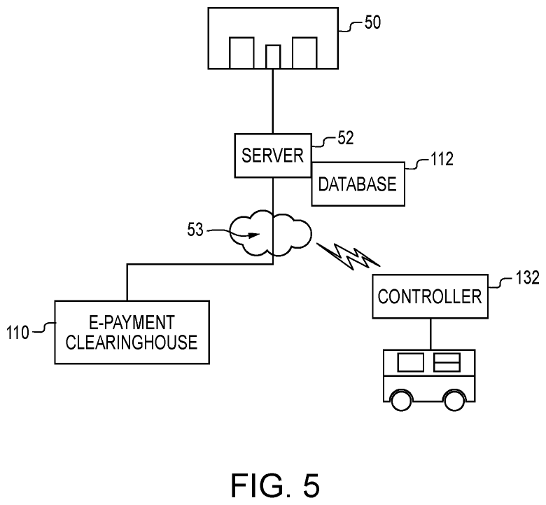

As illustrated in FIG. 5, the server 52 may be located at the remote location 50. An E-Payment clearinghouse 110 and a database 112 may be coupled with the server 52. The vending machine 100 may be equipped with a controller 132 in order to communicate with the server 52 via the network 53. A Secured Socket Layer (SSL) may be used for data encryption during the transmission and reception of data between the server 52 and the vending machine 100. The database 112 may store the data, which may include the location of the vending machine 100, performance data of the autonomous vehicle 10, current stock of product, transaction files and the like. The server 52 may further send the transaction files to the E-Payment clearinghouse 110 before the end of the day for clearance. The sequence of work of the vending machine 100 may be further discussed subsequently.

It may be understood that the server 52 may also be implemented in a variety of computing systems, such as a laptop computer, a desktop computer, a notebook, a workstation, a mainframe computer, a computer, a network computer, and the like. It will be understood that the server 52 may be accessed through one or more computing systems or applications residing on the computing systems. Examples of the computing systems may include, but are not limited to, a portable computer, a personal digital assistant, a handheld device, and a workstation. The computing systems may be communicatively coupled to the server 52 through the network 53.

In one embodiment, the network 53 may be a wireless network. The network 53 can be implemented as one of the different types of networks, such as intranet, local area network (LAN), wide area network (WAN), the internet, and the like. The network 53 may be either a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 53 may include a variety of network devices, including routers, bridges, computers, computing devices, storage devices, and the like.

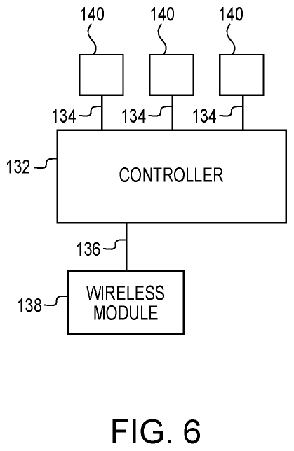

FIG. 6 illustrates an architecture of the controller 132 used for the vending machine 100. The controller 132 may be designed to control the vending machine 100. The controller 132 may use a 32-bit or 64-bit microprocessor, and may further include a Random-Access Memory (RAM) and a memory.

Generally, the vending machine 100 is placed in the outdoor environment withstanding extreme hot and low temperatures. In order to have prolonged reliability, the vending machine 100 may comprise a fan-less design along with adequate heat sink based on heat dissipation.

The controller 132 may further include multiple serial interfaces 134 connected to components 140 of the vending machine 100 known to those skilled in the art and one or more Universal Serial Bus (USB) interfaces. The USB interfaces 136 may communicate with a wireless module 138. Further, the interfaces may enable the controller 132 to communicate with other computing devices, such as web computers and external data computers (not shown). The interfaces 134, 136 can facilitate multiple communications within a wide variety of networks and protocol types, including wired networks, for example, LAN, cable, etc., and wireless networks, such as WLAN, Wi-Fi, cellular, or satellite. The interfaces may include one or more ports for connecting a number of devices to one another or to another computer.

The vending machine 100 may send payment transaction files and inventory data to the server 52 remotely. In order to restock the vending machine 100, the following steps may be involved.

The vending machine 100, as described, may send to the server 52 at the remote location 50 a notice or message that restocking may need to occur. At the remote location, product may be collected to be shipped to the vending machine 100 by any system known to those skilled in the art. In one embodiment, illustrated in FIG. 3, the restocking may be accomplished by a drone 200 flying the collected product, schematically illustrated in close-up 202 of FIG. 3, from the remote location 50 to the vending machine 100. When the drone 200 reaches the vending machine 100, a signal may be sent to a door 204 on top of the vending machine 100 to open the door 204. The collected product 202 may then be deposited in the vending machine 100, where it may be sorted by size, markings, UPC or other product codes, or by any other mechanical methods known to those skilled in the art. Once the delivery is completed, the door 204 may be signaled to close, and the drone 200 directed, by either the controller 132 on the vending machine 100 or the server 52 at the remote location 50, to return to the remote location 50. Restocking may occur on a regular time schedule or on demand as deemed necessary by programming on the controller 132.

Additional features using drone 200 may be applied, such as the vending machine 100 receiving orders for products not provided in the vending machine but stored in the remote location 50. The drone 200 may deliver the ordered product to the vending machine 100 for delivery to one of the group of customers 24.

In the previous embodiments, the controller 32 for the autonomous vehicle 10 and the controller 132 for the vending machine 100 are described as separate controllers. In an alternate embodiment, the controller 132 may be merged with controller 32 to make only one controller necessary for operating the autonomous vehicle 10 and the vending machine 100.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

1. A system for providing goods to a customer, comprising:
an autonomous vehicle, the autonomous vehicle comprising:
a first controller;
a camera in communication with the first controller for supplying image data to the controller;
a global positioning satellite apparatus for determining a position of the autonomous vehicle in communication with the first controller;
a ranging unit for determining a distance to an object from the autonomous vehicle in communication with the first controller; and
a communication system for wirelessly communicating with an off-board computer at a remote location; and
a mobile vending machine affixed to the autonomous vehicle, the mobile vending machine comprising:
a second controller;
a user interface for taking an order from the customer in communication with the second controller;
a delivery apparatus in communication with the second controller for delivering the order to the customer;
a restocking apparatus for replenishing goods in the mobile vending machine from the remote location, the restocking apparatus being in communication with the remote location and the mobile vending machine through the communication system; and
a restocking door, the restocking door opening to receive goods from the restocking apparatus to restock the mobile vending machine.

2. (canceled)

3. The system of claim 1 wherein the communication system is an embedded cellular telephone in electrical communication with the first controller.

4. The system of claim 3 wherein the embedded cellular telephone is in electrical communication with the second controller.

5. The system of claim 1 wherein the communication system is a wireless network transceiver in electrical communication with the first controller.

6. The system of claim 5 wherein the wireless network transceiver is in electrical communication with the second controller.

7. (canceled)

8. The system of claim 1 wherein the restocking apparatus comprises:
a drone for delivering goods from the remote location to the mobile vending machine, and
wherein the restocking door opens to receive goods from the drone to restock the mobile vending machine.

9. The system of claim 1 wherein the delivery apparatus comprises:
a robotic arm in communication with the second controller for delivering the order to the customer.

10. The system of claim 1 wherein the delivery apparatus comprises:
a cup and beverage dispenser.

11. The system of claim 1 wherein the delivery apparatus comprises:
a drawer for dispensing goods to the customer.

12. The system of claim 1 wherein the first controller and the second controller are integrated into a single electronic control unit.

13. The system of claim 1 wherein the autonomous vehicle further comprises:
an infrared sensor in communication with the first controller for identifying the location of the customer.

14. The system of claim 1 wherein the first controller is configured to:
direct the autonomous vehicle along a course to the customer; and
stop the autonomous vehicle if the customer is detected by the ranging unit within a specified distance of the autonomous vehicle.

15. A method of providing goods to a consumer using an autonomous vehicle, the autonomous vehicle comprising a controller, a camera in communication with the controller, a global positioning satellite apparatus in communication with the controller, a ranging unit in communication with the controller, and a mobile vending machine affixed to the autonomous vehicle, the method comprising the steps of:
determining the position of the autonomous vehicle using the global positioning satellite apparatus;
identifying a group of customers from image data provided by the camera to the controller;
identifying a distance to the group of customers using the ranging unit;
plotting a course for the autonomous vehicle to the group of customers using data from the global positioning satellite apparatus, camera, and ranging unit;
directing the autonomous vehicle along the course to the group of customers; and
stopping the autonomous vehicle if one of the group of customers is detected by the ranging unit within a specified distance of the autonomous vehicle.

16. The method of claim 15 further comprising the step of:
making the mobile vending machine available to the group of customers.

17. The method of claim 16 further comprising the steps of:
identifying that the mobile vending machine needs to be restocked;
communicating a message to a remote location with an order for goods to restock the mobile vending machine;
loading goods onto a drone to restock the mobile vending machine;
delivering goods using the drone from the remote location to the mobile vending machine; and
restocking the mobile vending machine.

18. A method of providing goods to a consumer using an autonomous vehicle, the autonomous vehicle comprising a controller, a camera in communication with the controller, a global positioning satellite apparatus in communication with the controller, a ranging unit in communication with the controller, an infrared sensor in communication with the first controller, and a mobile vending machine affixed to the autonomous vehicle, the method comprising the steps of:
determining the position of the autonomous vehicle using the global positioning satellite apparatus;
identifying a group of customers from data provided by the infrared sensor to the controller;
identifying a distance to the group of customers using the ranging unit;
plotting a course for the autonomous vehicle to the group of customers using data from the global positioning satellite apparatus, infrared sensor, and ranging unit;
directing the autonomous vehicle along the course to the group of customers; and
stopping the autonomous vehicle if one of the group of customers is detected by the ranging unit within a specified distance of the autonomous vehicle.

19. The method of claim 18 further comprising the step of:
making the mobile vending machine available to the group of customers.

20. The method of claim 19 further comprising the steps of:
identifying that the mobile vending machine needs to be restocked;
communicating a message to a remote location with an order for goods to restock the mobile vending machine;
loading goods onto a drone to restock the mobile vending machine;
delivering goods using the drone from the remote location to the mobile vending machine; and
restocking the mobile vending machine.
